(19) United States
(12) Patent Application Publication
(10) Pub. No.: US 2025/0154036 A1
(43) Pub. Date: May 15, 2025

(54) COMPOSITIONS AND METHODS OF USE FOR ENHANCED SOIL REMOVAL AND FAT, OIL, AND GREASE REDUCTION IN DRAIN PRODUCTS AND DISCHARGES INTO WATER SOURCES

(71) Applicant: ECOLAB USA INC., Saint Paul, MN (US)

(72) Inventors: Clinton Hunt,, JR., Lakeville, MN (US); Victor Fuk-Pong Man, Saint Paul, MN (US)

(21) Appl. No.: 18/945,794

(22) Filed: Nov. 13, 2024

Related U.S. Application Data
(60) Provisional application No. 63/598,210, filed on Nov. 13, 2023.

(51) Int. Cl. C02F 1/68; C02F 101/32

(52) U.S. Cl. CPC C02F 1/681; C02F 2101/325; C02F 2305/04

(57) ABSTRACT

Methods of using cleaning compositions for reducing fat, oil, and grease (FOG) and enhancing soil removal for improved FOG discharge are disclosed. Cleaning compositions comprising a demulsifier, an alkalinity source and at least one additional functional ingredients to effectively destabilize FOG in a waste water source, a discharge, drain, grease trap or grease interceptor, or the like are provided. Methods of using the compositions to substantially decrease FOG discharges into water sources with or without the use of drain cleaners are also provided.

### CROSS REFERENCE TO RELATED APPLICATIONS

This application claims priority under 35 U.S.C. § 119 to provisional patent application U.S. Ser. No. 63/598,210, filed Nov. 13, 2023. The provisional patent application is herein incorporated by reference in its entirety.

### TECHNICAL FIELD

The disclosure is directed to methods of using cleaning compositions for reducing fat, oil, and grease (FOG) and enhancing soil removal for improved FOG discharge. The cleaning compositions comprise a demulsifier, an alkalinity source and at least one additional functional ingredient to effectively destabilize FOG in a waste water source, a discharge, drain, grease trap or grease interceptor, or the like. The demulsifier can also be added to cleaning compositions comprising an emulsifying surfactant to destabilize FOG. Methods of using the compositions to substantially decrease FOG discharges into water sources with or without the use of drain cleaners are also provided.

### BACKGROUND

Increased user and regulatory scrutiny has been placed on the quality of water discharged from various institutional, industrial and commercial facilities. Such facilities often discharge water containing varying types of treated or untreated water and waste sources into publicly owned treatment works (POTWs). In particular varying emulsified agents, including fats, oils and grease (FOGs) are increasingly discharged into POTWs presenting processing challenges. This creates a significant problem for municipalities as the FOGs from various sources, including the institutional, industrial and commercial facilities along with residential buildings and homes accumulate and create issues for plumbing and in sewage lines and water treatment systems. Reduction in the FOG introduced into these systems can significantly reduce costs and challenges.

These emulsified FOGs can result from effective cleaning compositions that emulsify such components to provide efficacious cleaning, however the emulsified FOGs are then challenging to break apart in POTWs. In certain facilities, grease traps or grease interceptors can aid in reducing FOG discharge into effluent sources. Grease traps or grease interceptors are a type of plumbing device that is installed in a drainage system to stop or intercept FOGs from entering into a waste water discharge. In general, waste water flows from a sink or drain into a tank where it cools and FOGs harden and can be separated or removed as they fill the grease trap and the ‘clear’ water is moved into a sanitary sewer or septic system. However not all facilities have these plumbing devices and there remains a need for improvements to either replace or reduce the need for such grease traps or grease interceptors as a mechanism to reducing FOG discharge.

In addition to matters of water discharge, the negative impacts of FOG discharge can be seen from the need for drain cleaning in various industrial, commercial, and residential facilities, which can become soiled during the course of normal use. As materials such as fatty substances (including FOG), protein, cellulose fibers, soap, and particulate debris are discarded down the drain, the materials can adhere to the drain. In particular, sidewalls of the drain accumulate such materials over time creating a source of bacterial growth, odors, and an attractant for undesirable pests such as drain flies. In the extreme, the drain can become completely plugged so that water and other debris back up at the drain inlet, creating a sanitary issue that is particularly problematic for commercial facilities subject to rigorous health and sanitation regulations.

To minimize such drain issues, many facilities clean its drains on a periodic basis using a drain cleaner. For example, a facility may perform a three step cleaning process on a drain in which the drain is first cleaned with a drain cleaner, then washed, and finally disinfected with a sanitizer. During such a process, the drain cleaner may be introduced into the drain using a mechanical foaming device that mixes the drain cleaner with air to create a foam. The foam may more evenly distribute the drain cleaner on the sidewalls of drain than if the drain cleaner is simply poured down the drain.

It is therefore an object of this disclosure to provide compositions for reducing FOG and enhancing soil removal.

It is a further object of this disclosure to provide compositions and methods of use that reduce the need for draining cleaning compositions as a result of reducing FOG and enhancing soil removal at an application of use thereby decreasing FOG passing through a drain in need of cleaning, or reducing cleaning frequency.

Other objects, embodiments and advantages of this disclosure will be apparent to one skilled in the art in view of the following disclosure, the drawings, and the appended claims.

### SUMMARY

It is a further object, feature, and/or advantage of the present disclosure to provide compositions and methods of use for reducing fat, oil, and grease (FOG) and enhancing soil removal. Beneficially the compositions and methods of use substantially decrease FOG discharges into water sources with or without the use of drain cleaners.

According to some aspects of the present disclosure, methods of reducing fat, oil, and grease discharge comprise: adding a demulsifier to a cleaning composition to form a use solution to contact the demulsifier with a source of fat, oil and grease; contacting the use solution with the demulsifier and cleaning composition with the source of fat, oil and grease for a sufficient amount of time to destabilize the fat, oil and grease in a waste water source, wherein the sufficient amount of time is at least about 10 minutes; and decreasing the fat, oil and grease discharge from the waste water source to less than or equal to about 250 ppm (mg/L); wherein the demulsifier comprises a capped block copolymer, a reverse EO/PO block copolymer, an alkyl capped alcohol ethoxylate, an alkyl pyrrolidone, a silicone polyol and/or silicone polyether; and wherein the cleaning composition comprises an emulsifying surfactant; and wherein the use solution comprises from about 10 ppm (mg/L) to about 100,000 ppm (mg/L) of the demulsifier.

According to additional aspects of the present disclosure, methods of using a demulsifier to destabilize fat, oil and grease in a water source comprising: contacting a water source with fat, oil, and grease with between about 10 ppm (mg/L) to about 100,000 ppm (mg/L) of a demulsifier to form a treated water source; wherein the contacting provides a dwell time of at least about 10 minutes that is a sufficient amount of time to destabilize the fat, oil, and grease; and reducing the fat, oil, and grease discharged with the treated water source to less than or equal to about 250 ppm (mg/L); wherein the demulsifier comprises a capped block copolymer, a reverse EO/PO block copolymer, an alkyl capped alcohol ethoxylate, an alkyl pyrrolidone, a silicone polyol and/or silicone polyether.

According to additional aspects of the present disclosure, compositions for reducing fat, oil, and grease discharge comprise: a demulsifier comprising a capped block copolymer, a reverse EO/PO block copolymer, an alkyl capped alcohol ethoxylate, an alkyl pyrrolidone, a silicone polyol and/or silicone polyether; an alkalinity source; and at least one additional functional ingredient, wherein the composition is a liquid or solid. In further embodiments, the compositions comprise: from about 20 to 70% of a strong alkali hydroxide, preferably 50% sodium hydroxide or 45% potassium hydroxide; from about 0.5 to 5% of a surfactant comprising an amphoteric surfactant, anionic surfactant or combination thereof; from about 0.5 to 5% of a defoamer comprising a capped block copolymer, a reverse EO/PO block copolymer, an alkyl capped alcohol ethoxylate, an alkyl pyrrolidone, a silicone polyol and/or silicone polyether; and water, wherein preferably the composition is a liquid concentrate.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a graph showing the variable phase analysis of temperature and rest/dwell time on fat, oils, and grease (FOG) discharges.

FIG. 2 is a graph showing the fat, oils, and grease (FOG) concentration in various types of water to assess water qualities against FOG concentration.

FIG. 3 is a graph showing the fat, oils, and grease (FOG) discharges in various exemplary products.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. It has been surprisingly found that various demulsifiers can be added to cleaning compositions or formulated in compositions, such as drain cleaners, to reduce FOG and enhance soil removal. In embodiments the compositions including the demulsifiers decrease the time for separating the emulsified FOG.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 11/2, and 43/4. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, surface tension, molecular weight, temperature, pH, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The terms “discharge” or specifically “FOG discharge” refers to the amount of the fat, oil, and grease that is dispersed in the treated water source or the waste water source that is treated with the use solution comprising the demulsifier as described herein. According to embodiments of the claimed invention, the methods according to the invention reduce the fat, oil, and grease discharged within a treated water source to less than or equal to about 250 ppm (mg/L), resulting in a discharge with decreased fat, oil, and grease content compared to an untreated waste water source.

The terms “fat, oil and grease,” “FOG,” or “FOGs” as used herein refers to various emulsified agents including fats, oils, grease, and/or water insoluble organics. As referred to herein the phases FOG, FOGs and even reference to fats, oils and grease does not require the presence of all three as distinct emulsified agents and instead is understood to include any combination of one or more emulsified fats, oils and/or grease. Moreover, fats, oils and grease are understood to include free fatty acids (existing as acid or deprotonated forms depending on pH), triglycerides, and formation of lime soap to include complexes within the fat, oil and grease.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “generally” encompasses both “about” and “substantially.”

The term “hard surface” refers to a solid, substantially non-flexible surface such as a counter top, tile, floor, wall, panel, window, plumbing fixture (e.g. drain), kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x″mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid, changes the properties of that liquid at a surface/interface.

The term “waste water source” refers to a variety of sources of discharged water from a variety of sources, systems or industries that are soiled and/or contaminated with FOGS, including for example, food and beverage, food service or food processing, steel, automotive, transportation, refinery, pharmaceutical, metals, paper and pulp, chemical processing, cooling water, and hydrocarbon processing industries, and the like. Waste water sources can be those discharged from a variety of water sources that are soiled and/or contaminated water with FOGS, including for example, waste water discharged from a factory, residential home, industrial processing, or the like. Waste water sources can also be those discharged that are soiled and/or contaminated water with FOGS from a variety of water sources within systems including for example, cooling water system, including an open recirculating system, closed and once-through cooling water system, boilers and boiler water system, petroleum well system, downhole formation, geothermal well, and other water system in oil and gas field applications, a mineral washing system, flotation and benefaction system, paper mill digester, washer, bleach plant, stock chest, white water system, paper machine surface, black liquor evaporator in the pulp industry, gas scrubber and air washer, continuous casting processes in the metallurgical industry, air conditioning and refrigeration system, process waters, including industrial and petroleum process water, indirect contact cooling and heating water, water reclamation system, water purification system, membrane filtration water system, food processing streams, waste treatment system, clarifier, liquid-solid application, municipal sewage treatment, municipal water system, potable water system, aquifer, water tank, sprinkler system, water system used in oil refinery industry, or water heater.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Compositions

The methods of reducing fat, oil, and grease discharge can be achieved by adding a composition comprising a demulsifier and the compositions may be provided as liquids or solids. The compositions may also be provided as concentrates or use solutions. In embodiments, liquid concentrate compositions are preferred.

The compositions can comprise, consist of or consist essentially of an alkalinity source, preferably a strong alkalinity source, a demulsifier, and at least one additional functional ingredient.

The compositions for reducing fat, oil, and grease discharge can preferably include a demulsifier comprising or selected from the group consisting of a capped block copolymer, a reverse EO/PO block copolymer, an alkyl capped alcohol ethoxylate, an alkyl pyrrolidone, a silicone polyol and/or silicone polyether, an alkalinity source, and at least one additional functional ingredient, wherein the composition is a liquid or solid.

The compositions can include from about 0.5 to 5% of the demulsifier comprising or selected from the group consisting of the capped block copolymer, a reverse EO/PO block copolymer, an alkyl capped alcohol ethoxylate, an alkyl pyrrolidone, a silicone polyol and/or silicone polyether, from about 20 to 70% of a strong alkali hydroxide as the alkalinity source, preferably 50% sodium hydroxide or 45% potassium hydroxide, and from about 0.5 to 5% of a surfactant comprising an amphoteric surfactant, anionic surfactant or combination thereof as the additional functional ingredient. The compositions can further include water when formulated into a liquid concentrate composition.

### Demulsifiers

The demulsifiers are included in compositions and methods for reducing fat, oil, and grease (FOG) and enhancing soil removal. Without being limited to a particular mechanism of action, the demulsifiers decrease the time for separating the emulsified FOG. Demulsifiers can include a capped block copolymer, a reverse EO/PO block copolymer, an alkyl capped alcohol ethoxylate, an alkyl pyrrolidone, and/or a silicone polyol.

In some embodiments, the demulsifiers are included in the compositions at an amount of at least about 0.1 wt-% to about 10 wt-%, about 0.5 wt-% to about 10 wt-%, about 0.5 wt-% to about 8 wt-%, about 0.5 wt-% to about 5 wt-%, about 0.5 wt-% to about 2 wt-%, about 1 wt-% to about 10 wt-%, about 1 wt-% to about 8 wt-%, about 1 wt-% to about 5 wt-%, or about 1 wt-% to about 2 wt-%. In addition, without being limited according to the disclosure, all ranges recited are inclusive of the numbers defining the range and include each integer within the defined range.

### Capped Block Copolymers

Capped block copolymers can be included as the demulsifier. Preferably, the capped block copolymers are multiarmed. Preferred block copolymers may have from about 1 to about 100 moles of EO and from about 1 to about 100 moles of PO, more preferably from about 1 to about 50 moles EO and from about 1 to about 50 moles PO. Some examples of block copolymers include:
—(PO)_{Y}(EO)ₓ—(EO)ₓ(PO)_{Y}—(EO)ₓ(PO)_{Y}(EO)ₓ—(PO)_{Y}(EO)ₓ(PO)_{Y}

wherein EO represents an ethylene oxide group, PO represents a propylene oxide group, and X and Y reflect the average molecular proportion of each alkylene oxide monomer in the overall block copolymer composition. A preferred EO/PO copolymer is represented by the formula (EO)ₓ(PO)_{Y}(EO)ₓ. In another embodiment, a preferred EO/PO copolymer is represented by the formula (PO)_{Y}(EO)ₓ(PO)_{Y}. Preferably X is in the range of about 1 to about 100 and Y is in the range of about 1 to about 100. In a more preferred embodiment, X is in the range of about 5 to about 90 and Y is in the range of about 5 to about 90. Preferably, X plus Y is in the range of about 2 to about 200, more preferably about 10 to about 180, still more preferably about 15 to about 150. It should be understood that each X and Y in a molecule can be different. In a preferred embodiment, the block copolymer can have a molecular weight (Mn-number average mw) greater than about 200 and less than about 25,000, more preferably from about 500 to about 25,000, most preferably from about 1000 to about 20,000.

These EO/PO block copolymers can include a compact alcohol EO/PO surfactant where the EO and PO groups are in small block form, or random form. In other embodiments, the alkyl alkoxylate includes an ethylene oxide, a propylene oxide, a butylene oxide, a pentalene oxide, a hexylene oxide, a heptalene oxide, an octalene oxide, a nonalene oxide, a decylene oxide, and mixtures thereof. The alkyl group can be linear or branched and is preferably C₁-C₁₈, more preferably C₁₀-C₁₈; most preferably it is a branched alkyl group. Exemplary commercially available surfactants are available, for example, under the tradename PLURONIC® and PLURONIC RR, TETRONIC®, and SURFONICR.

In a preferred embodiment, the block copolymer comprises a linear or multiarmed EO/PO structures. Most preferably, the block copolymer is a “reverse” block copolymer with the EO inside and the PO on the terminal end. Non-limiting examples are shown below:

(PO)_{y}(EO)ₓ(PO)_{y}

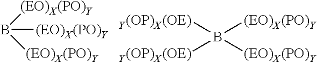

where B is an organic molecule with a polyfunctional moieties, such as a polyol, ethylene diamine, or diethylenetriamine, etc., as the starting point where the arms attach. It should be understood that these are not representative of the orientations of the arms, but merely representative of the potential formulations for purposes of illustrating the attachment of the alkoxylated arms to the starting polyfunctional moiety. Further, X and Y are defined further below where the degree of ethoxylation and propoxylation are discussed.

The capped block copolymers disclosed herein include what is often referred to as a “reverse” structure, that is, the EO groups are on the inside and the PO groups are on the outside, (PO)_{Y}(EO)ₓ(PO)_{Y}. Typical reverse block copolymers useful as demulsifiers have ethoxylation up to about 20% and those useful as wetting agents have ethoxylation between about 20% and 40%. However, typical reverse block copolymers for defoamer or wetting are not capped. Additionally, reverse block copolymers due not usually exhibit both good wetting and defoaming properties, instead they are typically selected for one or the other based on the degree of ethoxylation.

Preferably the ethoxylation is greater than about 20%, more preferably greater than about 20% and up to about 60%, still more preferably from about 25% to about 55%, even more preferably from about 30% to about 50%, still more preferably from about 35% to about 45%, most preferably about 40%.

Preferably the propoxylation is less than about 80%, more preferably from about 40% to less than about 80%, still more preferably from about 45% to about 75%, even more preferably from about 50% to about 70%, still more preferably from about 55% to about 65%, most preferably about 60%.

As used herein “arm(s)” refers to the alkoxylated chains; thus a multiarmed capped block copolymer would have more than one alkoxylated chain. The capped block copolymers preferably are multiarmed having at least 2 arms, more preferably at least 3 arms, even more preferably 3-6 arms, still more preferably 4 or 5 arms, and most preferred 4 arms. Preferably, the arms are formed by a branched alkyl group (backbone), which the block copolymer arms attach to. Non-limiting examples of 2 arms, 3 arms, and 4 arms are shown below for illustrative purposes:

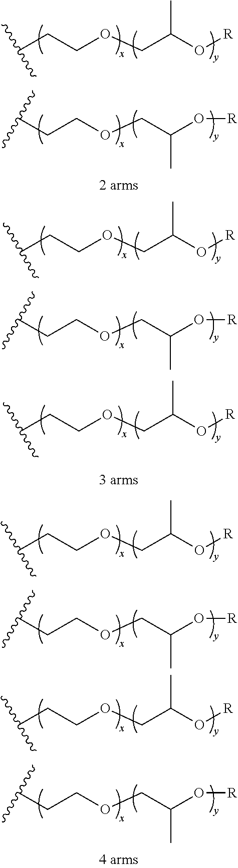

where R is a hydrophobic capping group as disclosed herein, X and Y are as defined above, each preferably between 1 and 100; and the EO/PO arms would be attached to a single backbone such that a single molecule is formed with at least 2 alkoxylated arms, at least 3 alkoxylated arms, at least 4 alkoxylated arms, at least 5 alkoxylated arms, or at least 6 alkoxylated arms. It should be understood that the block copolymer can have arms of different degrees of ethoxylation and/or propoxylation. Additionally, different arms of the block copolymer can have different hydrophobic capping groups at the terminus of each.

It should be understood that the number of arms, nature of the alkyl backbone, and percentages of ethoxylation and propoxylation on the arms can be determined by using a preexisting block copolymer surfactant and capping it according to the methods disclosed herein.

The multi-arm capped, reverse block copolymers are capped, i.e., the terminus of each arm is capped with a capping chemistry. Preferred capping chemistries are hydrophobic groups. More preferably, the hydrophobic group comprises a benzyl group and/or a substituted silyl group (R₁R₂R₃Si—) shown below:

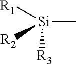

where each of R₁, R₂, and R₃ comprises an alkyl group, a phenol group, or tert-butyl.

Preferred alkyl groups for R₁, R₂, and/or R₃ include straight-chain alkyl groups having between 1 and 10 carbons (i.e., methyl, ethyl, propyl, butyl, pentyl, hexyl, heptyl, octyl, nonyl, and decyl); cyclic alkyl groups (or “cycloalkyl” or “alicyclic” or “carbocyclic” groups), including, but not limited to, cyclopropyl, cyclopentyl, cyclohexyl, cycloheptyl, cyclooctyl, cyclononyl, and cyclodecyl; branched-chain alkyl groups, including, but not limited to isopropyl, tert-butyl, sec-butyl, isobutyl; and alkyl-substituted alkyl groups, including but not limited to, alkyl-substituted cycloalkyl groups and cycloalkyl-substituted alkyl groups.

More preferably the hydrophobic group comprises a benzyl group, trimethylsilyl (TMS), triethylsilyl (TES), tert-butyldimethylsilyl (TBS), tert-butyldiphenylsilyl (TBDPS), triisopropylsilyl (TIPS), or a combination thereof. These preferred silyl-based capping chemistries are shown below:

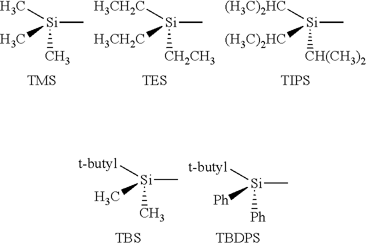

In the instance where there is a combination of hydrophobic groups utilized, this is due to capping of the different arms (e.g., two arms capped with TIPS and two arms capped with a benzyl group). Most preferably the hydrophobic group comprises a benzyl group, trimethylsilyl (TMS), triisopropylsilyl (TIPS), or a combination thereof.

In an embodiment where the block copolymer has two arms, one or both arms can be capped. In an embodiment where the block copolymer has three arms, one, two or three arms can be capped. In an embodiment where the block copolymer has four arms, one, two, three or four arms can be capped. In an embodiment where the block copolymer has five arms, one, two, three, four or five arms can be capped. In an embodiment where the block copolymer has six arms, one, two, three, four, five, or six arms can be capped.

Beneficially, the capped block copolymers disclosed herein have a low surface tension. Preferably a surface tension of less than about 35 dynes/cm, more preferably less than about 34 dynes/cm, still more preferably less than about 33 dynes/cm, even more preferably less than about 32 dynes/cm, yet more preferably less than about 31 dynes/cm, still more preferably less than about 30 dynes, even more preferably less than about 29 dynes, yet more preferably less than about 28 dynes/cm, still more preferably less than about 27 dynes/cm, even more preferably less than about 26 dynes/cm, yet more preferably less than about 25 dynes/cm, still more preferably less than about 24 dynes, even more preferably less than about 23 dynes, yet more preferably less than about 22 dynes/cm, still more preferably less than about 21 dynes, most preferably about 20 dynes/cm or less; when tested under ambient temperature and humidity.

### Reverse EO/PO Block Copolymer

Reverse EO/PO block copolymers can be included as the demulsifier. A “reverse” EO/PO block copolymer structure has EO groups on the inside and the PO groups are on the outside, (PO)_{Y}(EO)ₓ(PO) Y wherein EO represents an ethylene oxide group, PO represents a propylene oxide group, and X and Y reflect the average molecular proportion of each alkylene oxide monomer in the overall block copolymer composition. The reverse EO/PO block copolymer surfactants can be linear or branched.

Typical reverse block copolymers useful as demulsifiers have ethoxylation up to about 20% and those useful as wetting agents have ethoxylation between about 20% and 40%. Additionally, reverse block copolymers due not usually exhibit both good wetting and defoaming properties, instead they are typically selected for one or the other based on the degree of ethoxylation.

In embodiments, the degree of ethoxylation of the first reverse EO/PO block copolymers is about 10-40%, about 20-40%, most preferably about 20%. In embodiments of the first surfactant, the propoxylation of the first reverse EO/PO block copolymers is about 60-90%, about 60-80%, most preferably about 80%. In addition, without being limited according to the disclosure, all ranges recited are inclusive of the numbers defining the range and include each integer within the defined range. Commercially available examples of the reverse EO/PO block copolymers include for example PLURONIC 25R₂ and SURFONIC LD097.

In an embodiment the demulsifier is a reverse EO/PO block copolymer of about 20-40% EO. In a further preferred embodiment the demulsifier is a reverse EO/PO block copolymer having about 20% EO/80% PO regardless of the number of arms in the surfactant structure.

In an embodiment, the ethoxylation of the reverse EO/PO block copolymers included as a demulsifier is about 40-50% and can have a linear or branched (i.e. arms) structure. In embodiments of the demulsifier, the propoxylation of the reverse EO/PO block copolymers is about 50-60%. In addition, without being limited according to the disclosure, all ranges recited are inclusive of the numbers defining the range and include each integer within the defined range. Commercially available examples of the EO/PO block copolymers included as a demulsifier include for example TETRONIC 90R4.

In an embodiment the demulsifier is a reverse EO/PO block copolymer having about 40% EO/60% PO.

### Alkyl Capped Alcohol Ethoxylate

Alkyl capped alcohol ethoxylates can be included as the demulsifier. Alkyl capped alcohol ethoxylate compounds have the following structure: R₁—O—(CH₂CH₂O)ₙ—R₂ where R₁ is a linear or branched (C₁₀-C₁₈)alkyl group, R₂ is C₁-C₄, and n is an integer in the range of 1 to 100.

In an embodiment the alkyl capped alcohol ethoxylate is a butyl capped alcohol ethoxylate, such as for example a lauryl fatty alcohol ethoxylate butylether or coconut fatty alcohol ethoxylate butylether. Commercially available examples of the alkyl capped alcohol ethoxylates included as a second surfactant for protein soil removal include for example surfactants sold under the tradename DEHYPON LS and DEHYPON LT or GENAPOL BE-2810 and GENAPOL BE-2410.

### Alkyl Pyrrolidone

An alkyl pyrrolidone surfactant can be included as the demulsifier. Pyrrolidones are heterocyclic ketones derived from a pyrrolidone. Alkyl pyrrolidones have the general structure:

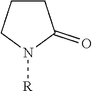

wherein R is a C_{6-C20} alkyl or RiNHCOR₂, wherein Riis C₁-C₆ alkyl and R₂ is C_{6-C20} alkyl.

In embodiments the alkyl pyrrolidone has the general structure shown above wherein R is C₈-C₁₀ alkyl pyrrolidone. In preferred embodiments the alkyl pyrrolidone is a C₈ or C₁₀ alkyl pyrrolidone. An example of a commercially available C₈ alkyl pyrrolidone (1-octyl-2-pyrrolidone) and a C₁₂ alkyl pyrrolidone are available under the tradename SURFADONE®.

### Silicone Polyols and Silicone Polyethers

A silicone polyol or a silicone polyether can be included as the demulsifier. An example of a commercially available silicone polyether is Tegopren 5852 which is a PEG/PPG dimethicone type.

### Alkalinity Source

The compositions and methods for reducing fat, oil, and grease (FOG) and enhancing soil removal include an alkalinity source. The source of alkalinity can be any source of alkalinity that is compatible with the other components of the composition. In some embodiments, the alkalinity source is a strong alkalinity source. Exemplary sources of alkalinity include alkali metal hydroxides, alkali metal carbonates, alkali metal silicates, alkali metal salts, phosphates, amines, and mixtures thereof, preferably alkali metal hydroxides including sodium hydroxide, potassium hydroxide, and lithium hydroxide or mixtures thereof, and most preferred is sodium hydroxide and/or potassium hydroxide.

In some embodiments, the alkalinity source is included in the compositions at an amount of at least about 20 wt-% to about 80 wt-%, about 30 wt-% to about 70 wt-%, about 40 wt-% to about 70 wt-%, about 45 wt-% to about 70 wt-%, or about 50 wt-% to about 70 wt-%. In addition, without being limited according to the disclosure, all ranges recited are inclusive of the numbers defining the range and include each integer within the defined range.

### Additional Functional Ingredients

The components of the compositions can further be combined with various functional components suitable for uses disclosed herein. In some embodiments, the compositions including the alkalinity source and demulsifier make up a large amount, or even substantially all of the total weight of the compositions. For example, in some embodiments few or no additional functional ingredients are disposed therein.

In some embodiments the compositions and methods of use described herein can exclude the use of certain nonionic polymers and compounds, including those that may in certain applications be known for use in separating soils from wastewater sources and removing sulfur-containing emulsions in sewer wastewaters. Exemplary nonionic polymer compound that can be excluded from the compositions and methods described herein include a homopolymer, copolymer, or terpolymer containing, as a constituent component, at least one type of monomer selected from the group consisting of acrylamide, ethylene oxide, propylene oxide, methyl vinyl ether, vinyl alcohol, and vinyl acetamide.

In some embodiments the compositions and methods of use described herein can exclude the use of associative thickeners, including those hydrophobically modified polymers described in U.S. Pat. No. 10,435,308, which are known to provide benefits for enhancing foam fractionation of oil from aqueous/oil mixed phases.

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the compositions may include additional surfactant, defoaming agents, anti-redeposition agents, bleaching agents, solubility modifiers, dispersants, antimicrobial agents, metal protecting agents, stabilizing agents, corrosion inhibitors, builders/sequestrants/chelating agents, enzymes, aesthetic enhancing agents including fragrances and/or dyes, additional rheology and/or solubility modifiers or thickeners, hydrotropes or couplers, buffers, solvents, additional cleaning agents and the like.

According to embodiments of the disclosure, the various additional functional ingredients may be provided in a composition in the amount from about 0 wt-% and about 50 wt-%, from about 0 wt-% and about 40 wt-%, from about 0 wt-% and about 30 wt-%, from about 0.01 wt-% and about 30 wt-%, from about 0.1 wt-% and about 30 wt-%, from about 1 wt-% and about 50 wt-%, from about 1 wt-% and about 40 wt-%, or from about 1 wt-% and about 30 wt-%. In addition, without being limited according to the disclosure, all ranges recited are inclusive of the numbers defining the range and include each integer within the defined range.

### Surfactants

The compositions and methods for reducing fat, oil, and grease (FOG) and enhancing soil removal can include a surfactant in combination with the demulsifier. In some embodiments the surfactant is referred to as an additional functional ingredient. The surfactant can include a mixture or combination of multiple surfactants, to provide cleaning properties, surface tension modification, and/or foaming, foam stabilization and/or defoaming properties. Examples of suitable surfactants that may be included in the compositions include water soluble or water dispersible nonionic, semi-polar nonionic, anionic, cationic, amphoteric, and zwitterionic surfactants, and combinations thereof. The particular surfactant(s) may depend for example on the foam building and maintaining properties of the surfactant, use pH, use temperature, and the type of soils to be cleaned.

In some embodiments, the composition containing the demulsifier includes an amphoteric surfactant, anionic surfactant or combination thereof.

In some embodiments, the composition containing the demulsifier includes an anionic surfactant. A surfactant may be categorized as anionic because the charge on the hydrophobe is negative (although the hydrophobic section of the molecule may carry no charge unless the pH is elevated to neutrality or above, such as in the case of a carboxylic acids). Carboxylate, sulfonate, sulfate and phosphate are examples of the polar (hydrophilic) solubilizing groups found in many anionic surfactants. The cations (counter ions) associated with these polar groups may include sodium, lithium, and/or potassium to impart water solubility; ammonium and/or substituted ammonium ions to provide both water and oil solubility; and, calcium, barium, and/or magnesium to promote oil solubility.

Exemplary anionic surfactants that may be used in the compositions include linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside. In some examples, the anionic surfactant is a synthetic, water soluble anionic surfactant compound that includes the ammonium and substituted ammonium (such as mono-, di- and triethanolamine) and alkali metal (such as sodium, lithium and potassium) salts of the alkyl mononuclear aromatic sulfonates such as the alkyl benzene sulfonates containing from about 5 to about 18 carbon atoms in the alkyl group in a straight or branched chain, e.g., the salts of alkyl benzene sulfonates or of alkyl toluene, xylene, cumene and phenol sulfonates; alkyl naphthalene sulfonate, diamyl naphthalene sulfonate, and dinonyl naphthalene sulfonate and alkoxylated derivatives. Other anionic surfactants that may be used in the compositions include olefin sulfonates, such as long chain alkene sulfonates, long chain hydroxyalkane sulfonates or mixtures of alkenesulfonates and hydroxyalkane-sulfonates.

In some embodiments, the anionic surfactant has a sulfate, sulfonate, and benzene sulfonate, phosphate, carboxylate, or sulfosuccinate group. For example, the anionic surfactant may include an anionic group that is a sulfate (e.g., a salt of a sulfate ester of a linear aliphatic alcohol). Example cations for the anionic surfactant may include one of potassium, ammonium, substituted ammonium salts, sodium, and magnesium. Representative anionic surfactants include sodium dodeccylbenzene sulfonate, sodium lauryl sulfate, magnesium lauryl sulfate, and sodium and magnesium undecyl sulfate. In embodiments when an alkyl sulfate anionic surfactant is used, the alkyl may, in different examples, be linear, branched, or include both linear and branched components. In some examples, however, the alkyl group is linear and not branched. In such examples, the polar group in the anionic surfactant may be attached to the terminal carbon atom (1-position) and the alkyl group extending from the terminal position may be 8 to 20 carbon atoms in length, such as 10 to 18 carbon atoms in length, or 11 to 16 carbon atoms in length. For example, as discussed above, the alkyl group in the surfactant may be a straight chain alkyl group, substituted in the 1-position, that contains twelve carbon atoms (i.e., the lauryl group).

In some embodiments, the composition includes an amphoteric surfactant, either in addition to or in lieu of an anionic surfactant. Amphoteric surfactants can be broadly described as derivatives of aliphatic secondary and tertiary amines in which the aliphatic radical may be straight chain or branched and where one of the aliphatic substituents contains from about 8 to 18 carbon atoms and one contains an anionic water solubilizing group, e.g., carboxy, sulfo, sulfato, phosphate, or phosphono. Amphoteric surfactants generally are subdivided into two major classes. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants may fit into both classes.

Examples of imidazoline-derived amphoterics that may be incorporated into the drain cleaner include, for example: cocoamphopropionate, cocoamphocarboxy-propionate, cocoamphoglycinate, cocoamphocarboxy-glycinate, cocoamphopropyl-sulfonate, and cocoamphocarboxy-propionic acid. Examples of N-alkylamino acid ampholytes that may be incorporated into the drain cleaner include, for example, alkyl beta-amino dipropionates, RN(C₂H₄COOM)₂ and RNHC₂H₄COOM. In these, R may be a acyclic hydrophobic group containing from about 8 to about 18 carbon atoms, and M a cation to neutralize the charge of the anion. In one example, the drain cleaner includes N-alkyl(C₁₂₋₁₄)dimethylamine oxide.

Exemplary nonionic surfactants that may be used in the compositions include for example surfactants having an HLB value between 10 and 22. Preferably, the HLB value is between about 11 and about 20, more preferably between about 12 and about 19, most preferably between about 13 and about 18. Preferably, the surfactant is an alkoxylated surfactant. Suitable alkoxylated surfactants include EO/PO copolymers, capped EO/PO copolymers, alcohol alkoxylates, capped alcohol alkoxylates, mixtures thereof, or the like. Preferred surfactants, including, but are not limited to, alcohol ethoxylates, polyethylene glycol sorbitan ester, polyethylene glycol ether, polyoxyethylene ether, a poly(propylene glycol)-block-poly(ethylene glycol)-block-poly(propylene glycol), poly(ethylene glycol)-block-poly(propylene glycol)-block-poly(ethylene glycol), or mixture thereof so long as the surfactant selected has an HLB value between 10 and 22. Suitable alkoxylated surfactants for use as solvents include EO/PO block copolymers, such as the Pluronic and reverse Pluronic surfactants; alcohol alkoxylates, such as Dehypon LS-54 (R-(EO) 5 (PO) 4) and Dehypon LS-36 (R-(EO) 3 (PO) 6); and capped alcohol alkoxylates, such as Plurafac LF221 and Tegoten EC11; mixtures thereof, or the like.

Additional exemplary nonionic surfactants include, for example, polyethylene glycol sorbitan monolaurate (commercially available as Tween 20 from Sigma-Aldrich), polyethylene glycol sorbitan monooleate (commercially available as Tween 80 from Sigma-Aldrich), polyethylene glycol tert-octylphenyl ether (commercially available as Triton X-100 from Sigma-Aldrich), polyethylene glycol trimethylnonyl ether (commercially available as Tergitol TMN—6 from Sigma-Aldrich), poly(propylene glycol)-block-poly(ethylene glycol)-block-poly(propylene glycol) (commercially available as Pluronic 10R₅ from Sigma-Aldrich, preferably having an average molecular weight of 1950), polyoxyethylene (23) lauryl ether (commercially available as Brij L23 from Sigma-Aldrich), and mixtures thereof.

### Methods of Use

The compositions and methods of using described herein are particularly useful in methods of reducing FOGs by destabilizing emulsified FOGs to reduce discharges from various institutional, industrial and commercial facilities. The reduction of FOG discharge can be regulated in various jurisdictions, including for example requiring≤250 ppm (mg/L) FOGs. The methods reduce FOG that is discharged into publicly owned treatment works (POTWs). The methods are intended to most frequently apply to treatment prior to waste water discharge from a facility with a grease trap, grease interceptor or the like, to further aid in reducing FOG discharge into effluent sources (e.g. discharged as waste water). However the methods as described herein can further be used to decrease FOG discharged into a waste water source from a facility without a discharge, drain, grease trap or grease interceptor.

The compositions and methods of using described herein are particularly useful in methods of reducing FOGs from discharges and applications that conventionally also require drain cleaning applications, which are not limited to any particular drain configuration. Moreover, the compositions and methods of using in accordance with the disclosure are not limited to such an application. Additional surfaces that may be cleaned using the composition include, but are not limited to, other hard surfaces, heat exchange coils, ovens, fryers, smoke houses, grease traps or grease interceptors, other drain lines, and the like.

In an embodiment, the methods provide steps for reducing fat, oil, and grease discharge. The methods include adding a demulsifier to a cleaning composition that comprises an emulsifying surfactant as is conventional in ware washing and other applications to remove soils from treated surfaces. The methods of providing the demulsifier to a cleaning composition that contains the emulsifying surfactant beneficially allows the removal of soils and the further destabilization of the fat, oil, and grease in a facility discharge, drain, grease trap or grease interceptor. Beneficially, the decreasing of the fat, oil and grease discharges into water sources is achieved either with or without the use of drain cleaners.

The methods as described herein are distinct from sewer, municipality or other waste water treatment steps that are aimed at removing soils for purposes of reuse of clean water. Instead, the methods presented herein provide an upstream method of reducing FOGs before they are introduced into such sewer, municipality or other waste water treatments.

In embodiments the addition of a demulsifier can be provided as a standalone component, provided as a composition with other components (as described herein with alkalinity source and additional functional ingredients), or provided with a cleaning composition containing the emulsifying surfactant.

In some embodiments the methods can be used by contacting the demulsifier or the composition containing the demulsifier with a hard surface, preferably a drain, in contact with or housing a water source with fat, oil and grease. Hard surfaces in contact with water sources containing fat, oil and grease include but are not limited to, drains, floors, sinks, beverage tower fluid lines, or combination thereof.

In some embodiments the methods include adding a demulsifier to a cleaning composition comprising an emulsifying surfactant to form a use solution to contact the demulsifier with a source of fat, oil and grease for a sufficient amount of time to destabilize the fat, oil and grease in a discharge, drain, grease trap or grease interceptor, and thereafter decreasing the fat, oil and grease discharges into a waste water source.

In further embodiments the methods include using a demulsifier to destabilize fat, oil and grease in a water source by contacting the water source with the fat, oil and grease with between about 10 ppm (mg/L) to about 100,000 ppm (mg/L) of a demulsifier to form a treated water source; wherein the allowed contact or dwell time is for a sufficient amount of time to destabilize the fat, oil and grease; and reducing the fat, oil and grease discharged with the treated water source.

Beneficially, in embodiments, the methods decreases the fat, oil and grease discharges in the waste water source and treated water source without the required additional use of a drain cleaner. In embodiments the demulsifier is added before the fat, oil and grease is discharged from a facility as a waste water source, including facilities with a discharge, drain, grease trap or grease interceptor.

In an aspect of the methods of use, the demulsifier is in contact with the fat, oil and grease at a sufficient concentration to destabilize the fat, oil, and grease in the soiled water source (also referred to as the treated water source), whereby the amount of fat, oil, and grease discharged from the treated water source is reduced. In embodiments the concentration of the demulsifier in a use solution of the demulsifier, the composition, and/or the cleaning composition (if applicable, e.g. a drain cleaner) will be between about 1 ppm (mg/L) to about 100,000 ppm (mg/L), from about 10 ppm (mg/L) to about 100,000 ppm (mg/L), from about 20 ppm (mg/L) to about 20,000 ppm (mg/L), or from about 30 ppm (mg/L) to about 10,000 ppm (mg/L), of the demulsifier.

In an aspect of the methods of use, the demulsifier and/or the composition can be allowed to contact the fat, oil and grease for a sufficient dwell time to destabilize the fat, oil, and grease in the soiled water source (also referred to as the treated water source), whereby the amount of fat, oil, and grease discharged from the treated water source is reduced.

In one embodiment of the present method the demulsifier and/or the composition is added directly to a hard surface, preferably a drain system through an opening in the system, such as a floor drain or any other opening that will allow access to the drain interior.

Preferably the demulsifier and/or the composition is in contact with the fat, oil and grease for a time prior to use, prior to discharging the water source therefrom, or prior to rinsing of at least about 1 minute, 5 minutes, 10 minutes, 11 minutes, 12 minutes, 13 minutes, 14 minutes, 15 minutes, 20 minutes, 25 minutes, 30 minutes, 40 minutes, 45 minutes, 1 hour, or greater.

In preferred embodiments the dwell time or sufficient amount of time to destabilize the fat, oil and grease in a waste water source is at least about 10 minutes, 15 minutes, 20 minutes, 25 minutes, 30 minutes, 40 minutes, 45 minutes, 1 hour, or greater. In further preferred embodiments the dwell time or sufficient amount of time to destabilize the fat, oil and grease in a waste water source is at least about 20 minutes, 25 minutes, 30 minutes, 40 minutes, 45 minutes, 1 hour, or greater.

The treated waste water source can have a temperature between 10° C. and about 140° C., preferably between about 25° C. and about 120° C., preferably between about 35° C. and about 110° C., or more preferably between about 50° C. and about 80° C.

Optionally, the hard surface housing the treated water source can be rinsed after allowing the demulsifier and/or the composition to contact the fat, oil and grease for a sufficient time. In a preferred embodiment, the hard surface housing the treated water source is not rinsed after contact with the composition. In another preferred embodiment, the hard surface housing the treated water source is rinsed with water. The water can have a temperature between 10° C. and about 100° C.

Beneficially the efficacy of the demulsifier and/or the compositions to destabilize the FOGs is not dependent on the type of water in the waste water and does not require treating water for hardness or to provide a desired hardness or softness. In embodiments the water in the waste water with FOGs can be from about 0 grain to about 17 grain or any range therebetween.

Optionally, the hard surface housing the treated water source can be further cleaned with a drain cleaner composition after allowing the demulsifier and/or composition to contact the fat, oil and grease for sufficient time.

The method of use requires no particular mode of contacting the demulsifier and/or composition to the hard surface in contact with the fat, oil and grease to be removed, provided the contacting takes place for a time sufficient to allow at least partially destabilizing and reducing the fat, oil and grease in the effluent, such as for example from the drain, grease trap or grease interceptor.

The methods reduce fat, oil and grease discharge to less than about 250 ppm (mg/L) as may be required in certain jurisdictions as a measurement for an environmental water discharge.

Optionally, the fats, oils and grease can be removed with minimal mechanical or manual effort, such as by flushing or rinsing, by gentle mechanical agitation, or by continued use of the compositions described herein. Preferably, the demulsifier and/or composition is permitted to contact the fat, oil and grease therein for at least about 10 minutes to about 3 hours.

The demulsifier and/or compositions and methods can be applied to effect both prevention and removal of soils and deposits comprising fats, oils and grease that would otherwise be discharged from a facility and/or eventually clog a drain (or other hard surface in contact therewith). For example, when used to clean drain pipes the condition of the drain must be ascertained, i.e., whether the drain is fully or partially clogged. If fully clogged, the drain can be partially unblocked, typically by mechanical means such as snaking, rotor rooting, water jetting, etc., to allow the composition to contact as much of the soils and deposits comprising fats, oils and grease as possible. However, it is also possible to apply the compositions to a fully clogged drain in small amounts repeatedly as it degrades the soils and deposits comprising fats, oils and grease.

### Embodiments

The present disclosure is further defined by the following numbered embodiments:
1. A method of reducing fat, oil, and grease discharge comprising: adding a demulsifier to a cleaning composition comprising an emulsifying surfactant to form a use solution to contact the demulsifier with a source of fat, oil and grease for a sufficient amount of time to destabilize the fat, oil and grease in a waste water source; and decreasing the fat, oil and grease discharge from the waste water source.
2. The method of embodiment 1, wherein the waste water source is housed or passes through a discharge, drain, grease trap or grease interceptor.
3. The method of any one of embodiments 1-2, wherein the method decreases the fat, oil and grease discharges in the waste water source without the additional use of a drain cleaner.
4. The method of any one of embodiments 1-3, wherein the demulsifier is added before the fat, oil and grease discharges from a facility with the discharge, drain, grease trap or grease interceptor.
5. The method of any one of embodiments 1-4, wherein the demulsifier is combined with an alkalinity source, preferably a strong alkalinity source, and preferably with an alkali metal hydroxide as the strong alkalinity source.
6. The method of any one of embodiments 1-5, wherein the demulsifier comprises at least one of a reverse EO/PO block copolymer, an alkyl capped alcohol ethoxylate, a capped block copolymer, an alkyl pyrrolidone, and/or a silicone polyol or silicone polyether.
7. The method of embodiment 6, wherein the reverse EO/PO block copolymer has about 40-50% EO, wherein the alkyl capped alcohol ethoxylate having the structure: R₁—O—(CH₂CH₂O)ₙ—R₂ where R₂ is a linear or branched (C₁₀-C₁₈)alkyl group, R₂ is C₁-C₄, and n is an integer in the range of 1 to 100, or wherein the alkyl pyrrolidone is C₈ or C₁₀ alkyl pyrrolidone.
8. The method of any one of embodiments 1-7, wherein the demulsifier is further combined with at least one additional functional ingredient comprising an amphoteric surfactant, anionic surfactant or combination thereof.
9. The method of any one of embodiments 1-8, wherein a use solution of the demulsifier and the cleaning composition comprises from about 10 ppm (mg/L) to about 100,000 ppm (mg/L), from about 20 ppm (mg/L) to about 20,000 ppm (mg/L), or from about 30 ppm (mg/L) to about 10,000 ppm (mg/L), of the demulsifier.
10. The method of any one of embodiments 1-9, wherein the sufficient amount of time is at least about 10 minutes, or at least about 20 minutes, and wherein the temperature of the waste water source is between about 10° C. and about 140° C.
11. The method of any one of embodiments 1-10, wherein the fat, oil and grease discharge is less than or equal to 250 ppm (mg/L).
12. A method of using a demulsifier to destabilize fat, oil and grease in a water source comprising: contacting a water source with fat, oil, and grease with between about 10 ppm (mg/L) to about 100,000 ppm (mg/L) of a demulsifier to form a treated water source; wherein the contacting provides a dwell time that is a sufficient amount of time to destabilize the fat, oil, and grease; and reducing the fat, oil, and grease discharged with the treated water source.
13. The method of embodiment 12, wherein the water source is an effluent from a facility and/or is housed in a discharge, drain, drain trap or grease interceptor.
14. The method of any one of embodiments 12-13, wherein the demulsifier is added to the water source before the treated water is discharged.
15. The method of any one of embodiments 12-14, wherein the demulsifier is combined with an alkalinity source, preferably a strong alkalinity source, and preferably with an alkali metal hydroxide as the strong alkalinity source.
16. The method of any one of embodiments 12-15, wherein the demulsifier comprises at least one of a reverse EO/PO block copolymer, an alkyl capped alcohol ethoxylate, a capped block copolymer, an alkyl pyrrolidone, and/or a silicone polyol or silicone polyether, and optionally further comprising at least one additional functional ingredient comprising an amphoteric surfactant, anionic surfactant or combination thereof.
17. The method of embodiment 16, wherein the reverse EO/PO block copolymer has about 40-50% EO, wherein the alkyl capped alcohol ethoxylate having the structure: R₁—O—(CH₂CH₂O)ₙ—R₂ where R₂ is a linear or branched (C₁₀-C₁₈)alkyl group, R₂ is C₁-C₄, and n is an integer in the range of 1 to 100, or wherein the alkyl pyrrolidone is C₈ or C₁₀ alkyl pyrrolidone.
18. The method of any one of embodiments 12-17, wherein the treated water source comprises from about 20 ppm (mg/L) to about 20,000 ppm (mg/L), or from about 30 ppm (mg/L) to about 10,000 ppm (mg/L), of the demulsifier.
19. The method of any one of embodiments 12-18, wherein the sufficient amount of time is at least about 10 minutes, or at least about 20 minutes, and wherein the temperature of the waste water source is between about 10° C. and about 140° C.
20. The method of any one of embodiments 12-19, wherein the fat, oil and grease discharge is less than or equal to 250 ppm (mg/L).
21. A composition for reducing fat, oil, and grease discharge comprising: a demulsifier comprising a capped block copolymer, a reverse EO/PO block copolymer, an alkyl capped alcohol ethoxylate, an alkyl pyrrolidone, a silicone polyol and/or silicone polyether; an alkalinity source; and at least one additional functional ingredient, wherein the composition is a liquid or solid.
22. The composition of embodiment 21, wherein the composition comprises: from about 20 to 70% of a strong alkali hydroxide, preferably 50% sodium hydroxide or 45% potassium hydroxide; from about 0.5 to 5% of a surfactant comprising an amphoteric surfactant, anionic surfactant or combination thereof; from about 0.5 to 5% of a defoamer comprising a capped block copolymer, a reverse EO/PO block copolymer, an alkyl capped alcohol ethoxylate, an alkyl pyrrolidone, a silicone polyol and/or silicone polyether; and water, wherein preferably the composition is a liquid concentrate.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following components are utilized in the Examples:

Dehypon LS 104L: a lauryl fatty alcohol ethoxy butylether DRM, commercially available from BASF.

Genapol BE 2410: a lauryl fatty alcohol ethoxy butylether DRM, commercially available from Dow Chemical.

Tegopren 5852: a PEG/PPG dimethicone silicone polyether, commercially available from Evonik.

Tetronic 90R4: tetra-functional block copolymers derived from the sequential addition of propylene oxide and ethylene oxide to ethylenediamine, commercially available from BASF.

Commercially available: oleic acid, water (0 gpg, 5 gpg, 11 gpg, 17 gpg, 25 gpg water, deionized water (DI water/H₂O), and Milli-Q water), coconut oil, corn oil, vegetable oil, sodium alkyl sulfosuccinate surfactant (DOSS), and potassium hydroxide.

### Example 1

A benchtop emulsification and extraction method, followed by oil and grease analysis per EPA Method 1664A was utilized for the testing. A Variable Phase Analysis (VPA) was utilized to determine optimum conditions (oil concentration, temperature, mix energy and dwell time) for evaluating FOG discharge. The VPA looked at 4 variables: rest/dwell time, temperature, water hardness, and mixing energy). After evaluation, optimum testing conditions were found to be 20 to 60 minutes of rest time, temperature at 50° to 110° F., 5 to 17 grain (gpg) water hardness, and both low and high energy mixing.

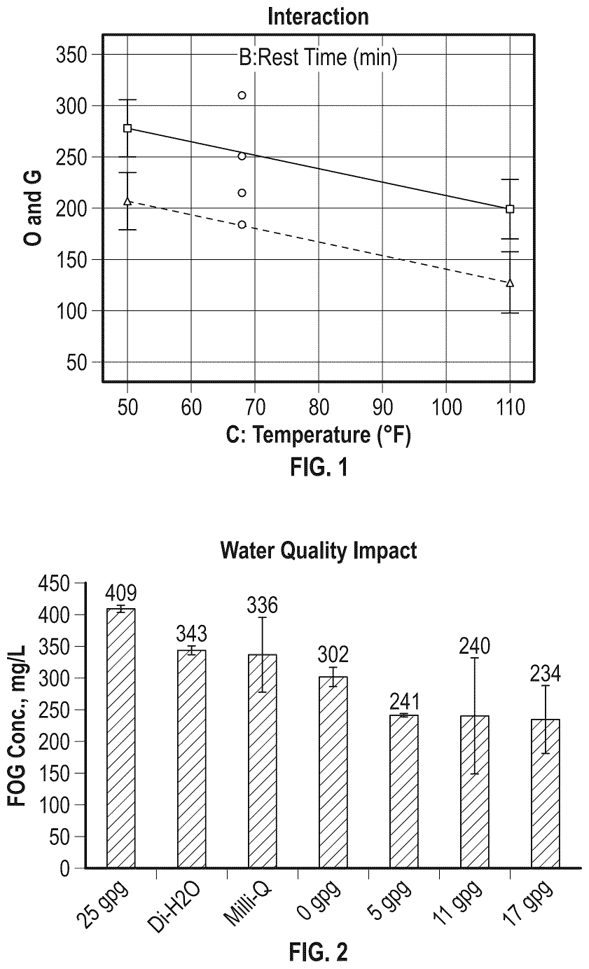

After completing the VPA it was determined to evaluate all products at ambient temperature, low mix energy, 40-minute dwell/rest time, and 11 grain water. FIG. 1 shows that temperature and rest/dwell time (shown as □=20 minutes and ▴=60 minutes) have the greatest impact on FOG discharges. As FIG. 1 demonstrates, the higher temperature facilitates phase separation, and increasing rest time also allows more oil phase rising to the top due to density differences from water, which is generally expected of emulsion behavior.

Similarly, water hardness impact on FOG discharges was evaluated. It is known that there is always an amount of free fatty acid in any triglyceride. The free fatty acid can exist as either as an acid form or a deprotonated form depending on the alkalinity of the water source. The deprotonated form can form lime soap with calcium in a water source. Thus, the emulsion can be complex, comprising the triglyceride, free fatty acid, and deprotonated fatty acids and/or lime soap and these elements can have different rates of rising to the top (i.e. breaking of emulsion).

Various water types were evaluated for impact on FOG discharges (shown in FIG. 1 as “O and G” referring to FOGs measured on ppm (mg/L)). Deionized water, Milli-Q water, 0 gpg, 5 gpg, 11 gpg, 17 gpg, and 25 gpg water were evaluated as shown in FIG. 2. Surprisingly, all levels of water hardness showed a significant influence on FOG discharges, even though large variations (standard deviations) in the results for 11 gpg and Milli-Q water are shown. These results show that water quality influences FOG discharges even without the introduction of enzymes and/or emulsifiers into the system.

### Example 2

After evaluating FOG discharges in plain water, evaluations with several commercially available products were completed to assess the role that demulsifiers have on controlling or increasing phase separation potential. 10 products were evaluated against 11 gpg water with 1% vegetable oil, 11 gpg water, room temperature, low energy mixing, and 40 minutes of rest/dwell time. The evaluated products are summarized in Table 1.

TABLE 1

| Product | Description |
|---|---|
| A | Commercial Drain Cleaner - Control |
| B | Warewash Dish Detergent - Control |
| C | Warewash Dish Detergent - Control with enzymatic formula |
| D | Background Solution - Control |
| E | Enzyme/Biobased Commercial Drain Cleaner - Control |
| F | Commercial Drain Cleaner - Control |
| G | Commercial Floor & Drain Cleaner - Control |
| H | Biological Drain/Cleaner - Control |
| I | Floor/Drain Cleaner - Control |
| J | Floor Cleaner - Control |
| K | Warewash Dish Detergent - Control with enzymatic formula |

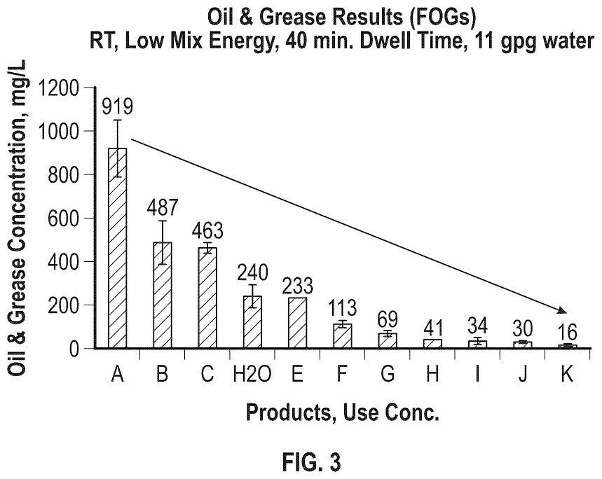

As shown in FIG. 3, Products E-K, showed lower FOG discharges than water. Conversely, Product A, a commercial drain cleaner, showed very high FOG discharges (919 ppm average). Products B and C, commercially available warewash dish detergent products, also exhibited higher FOG discharges than 11 gpg water. These comparisons of commercial products containing various surfactants, including emulsifying surfactants, although effective at soil removal only enhance FOGs discharged and need improvements for processing and reducing FOGs as described according to the methods and compositions contained herein.

Further analysis of the FOG discharges from Product A, formulation with water, a high level of potassium hydroxide (high alkalinity), and a low level of sodium alkyl sulfosuccinate surfactant (DOSS) was undertaken. The use of DOSS was not expected to be stable in higher alkaline environment. Without being limited by a particular mechanism of action or theory, it is thought that DOSS, as a good dispersant, is stabilizing the complex oily emulsion, therefore resulting in a high FOG value. Further testing using a demulsifier to destabilize the complex emulsions was evaluated to assess reduction of the FOG discharges.

### Example 3

Evaluation of sample formulations 9 and 10 as described in Tables 2 and 3 were prepared in deionized water based on modified drain cleaner formulations with the addition of demulsifiers Tetronic 90R4 and Tegopren 5852, respectively.

TABLE 2
Sample 9

| Description | Wt., % |
|---|---|
| Water Deionized | 30-35 |
| Sodium Alkyl Sulfosuccinate, 35% | <1 |
| Tetronic 90R4 | 1.00 |
| POTASSIUM HYDROXIDE, 45% LIQUID | 60-65 |
| Total | 100 |

TABLE 3
Sample 10

| Description | Wt., % |
|---|---|
| Water Deionized | 30-35 |
| Sodium Alkyl Sulfosuccinate 35% | <1 |
| Tegopren 5852 | 1.01 |
| POTASSIUM HYDROXIDE, 45% LIQUID | 60-65 |
| Total | 100.1 |

Samples 9 and 10 were evaluated against samples that contained various water hardness levels (0 and 25 gpg; FIG. 2) and saturated coconut oil or unsaturated oleic acid to demonstrate impact of reducing FOG. The results are compared in Table 4.

TABLE 4

| | H₂O, | Oil, | Total, | Wt. % | H₂O | O & G, | |
|---|---|---|---|---|---|---|---|
| Sample | g | g | g | Oil | °H, gpg | mg/L | FA Type/Class |
| 1 | 1500.79 | 15.01 | 1515.80 | 0.99 | 0 | 255 | Saturated/Coconut Oil |
| 2 | 1500.61 | 15.05 | 1515.66 | 0.99 | 0 | 574 | Saturated/Coconut Oil |
| Average (1 & 2) | | | | | | 415 | |
| Corrected/Adjusted using FIG. 1 for 0 gpg (302 | | | | | | 113 | |
| mg/L), subtracted H2O value from the reported value. | | | | | | | |
| 3 | 1500.14 | 15.01 | 1515.15 | 0.99 | 17 | 206 | Saturated/Coconut Oil |
| 4 | 1500.12 | 15.24 | 1515.36 | 1.01 | 17 | 184 | Saturated/Coconut Oil |
| Average (3 & 4) | | | | | | 195 | |
| Corrected/Adjusted using FIG. 1 for 17 gpg (234 | | | | | | <0 | |
| mg/L), subtracted H2O value from the reported value | | | | | | | |
| 5 | 1499.93 | 15.03 | 1514.96 | 0.99 | 0 | 159 | Unsaturated/Oleic Acid |
| 6 | 1499.81 | 15.01 | 1514.82 | 0.99 | 0 | 184 | Unsaturated/Oleic Acid |
| Average (5 & 6) | | | | | | 172 | |
| Corrected/Adjusted using FIG. 1 for 17 gpg (234 | | | | | | <0 | |
| mg/L), subtracted H2O value from the reported value | | | | | | | |
| 7 | 1499.96 | 15.02 | 1514.98 | 0.99 | 17 | 188 | Unsaturated/Oleic Acid |
| 8 | 1500.32 | 15.02 | 1515.34 | 0.99 | 17 | 265 | Unsaturated/Oleic Acid |
| Corrected/Adjusted using FIG. 1 for 17 gpg (234 | | | | | | <0 | |
| mg/L), subtracted H2O value from the reported value | | | | | | | |
| Average (7 & 8) | | | | | | 227 | |
| 9 | 1500.10 | 16.92 | 1517.02 | 1.12 | DI | 11.90 | Unsaturated/Oleic Acid |
| 10 | 1500.18 | 16.35 | 1516.53 | 1.08 | DI | 6.80 | Unsaturated/Oleic Acid |

| | |
|---|---|
| Average (9 & 10) | 9.35 |

As shown in Table 4, samples 9 and 10 showed significantly lower FOG discharges (11.9 mg/L FOG for Sample 9 and 6.8 mg/L FOG for Sample) than those samples with no demulsifiers (Samples 1-8), where the averages ranged from 172-415 mg/L FOG. This shows the beneficial impact of the demulsifying agents in providing a significant reduction of FOG discharges when compared to the result for DI-H₂O in FIG. 1 which showed a FOG discharge of approximately 343 mg/L.

### Example 4

A commercial drain cleaner formulation was modified in Samples 1-3 through 1-6 with the respective demulsifiers, Tetronic 90R4 or Tegopren 5852, and evaluated in DI water, and corn oil or vegetable oil. These samples were compared to Samples 1-1 and 1-2, which combined 0 gpg water (no alkalinity), saturated coconut oil, and 1 wt-% of Tetronic 90R4 (Sample 1-1) or Tegopren 5852 (Sample 1-2). The results are summarized in Table 5.

TABLE 5

| | H₂O, | Demul., | Oil, | Wt. % | H₂O | O & G, | FA |
|---|---|---|---|---|---|---|---|
| Sample Number | g | g | g | Oil | °H, gpg | mg/L | Type/Class |
| 1-1 w/1% 90R4 | 1488.24 | 15.32 | 15.25 | 1.01 | 0 | 1960.0 | Coconut |
| | | | | | | | Oil/saturated |
| 1-2 w/1% 5852 | 1501.80 | 15.20 | 15.05 | 0.99 | 0 | 327.0 | Coconut |
| | | | | | | | Oil/saturated |
| 1-3 (Comm. Drain | 1486.90 | 15.07 | 15.15 | 1.01 | Comm. Drain | 24.1 | Comm. |
| Cleaner + Corn | | | | | Cleaner | | Drain |
| Oil w/1% 90R4) | | | | | supplied in | | Cleaner + |
| | | | | | DI-H2O | | Corn Oil |
| 1-4 (Comm. Drain | 1488.57 | 19.44 | 16.61 | 1.10 | Comm. Drain | 10.6 | Comm. |
| Cleaner + Corn | | | | | Cleaner | | Drain |
| Oil w/1% 5852) | | | | | supplied in | | Cleaner + |
| | | | | | DI-H2O | | Corn Oil |
| 1-5 (Comm. Drain | 1485.30 | 15.30 | 15.16 | 1.01 | Comm. Drain | 11.0 | Comm. |
| Cleaner + 1% | | | | | Cleaner | | Drain |
| 90R4) | | | | | supplied in | | Cleaner + |
| | | | | | DI-H2O | | Veg. Oil |
| 1-6 (Comm. Drain | 1485.14 | 15.17 | 16.99 | 1.13 | Comm. Drain | 8.7 | Comm. |
| Cleaner + 1% | | | | | Cleaner | | Drain |
| 5852) | | | | | supplied in | | Cleaner + |
| | | | | | DI-H2O | | Veg. Oil |

Table 5 shows that compared to the results of 0 gpg water alone, shown in FIG. 2, Sample 1-1 was significantly higher and Sample 1-2 was about the same amount of FOG discharge. The results with high FOG discharges compared to Samples 1-3 through 1-6, confirms the role of the alkalinity in reducing FOG discharge. Samples 1-3 through 1-6 showed much lower FOG discharges when compared to the discharges of DI water in FIG. 2.

### Example 5

Tables 6-8 show sample formulations with Tetronic 90R4, Tegopren 5852, or Dehypon LS 104L/Genapol BE 2410 and DI water that were evaluated for impact on FOG discharge.

TABLE 6
Sample 2-1

| Description | Wt., % |
|---|---|
| Water Deionized | 32-38 |
| Sodium Alkyl Sulfosuccinate, 35% | <1 |
| Tetronic 90R4 | 0.88 |
| POTASSIUM HYDROXIDE, 45% LIQUID | 60-65 |
| Total | 100 |

TABLE 7
Sample 2-2

| Description | Wt., % |
|---|---|
| Water Deionized | 32-38 |
| Sodium Alkyl Sulfosuccinate, 35% | <1 |
| Tegopren 5852 | 1.01 |
| POTASSIUM HYDROXIDE, 45% LIQUID | 60-65 |
| Total | 100 |

TABLE 8
Sample 2-3

| Description | Wt., % |
|---|---|
| Water Deionized | 32-38 |
| Sodium Alkyl Sulfosuccinate, 35% | <1 |
| Dehypon LS 104L/Genapol BE 2410 | 1.01 |
| POTASSIUM HYDROXIDE, 45% LIQUID | 60-65 |
| Total | 100 |

Table 9 shows the FOG discharge results of the various evaluated samples.

TABLE 9

| Sample | H₂O, | Oil, | Total, | Wt. % | H₂O | O & G, | |
|---|---|---|---|---|---|---|---|
| Number | g | g | g | Oil | °H, gpg | mg/L | Fatty Acid Type/Class |
| 2-4 | 1499.57 | 14.99 | 1514.56 | 0.99 | 0 | 136 | Saturated/Coconut Oil |
| 2-5 | 1500.41 | 15.02 | 1515.43 | 0.99 | 0 | 134 | Saturated/Coconut Oil |
| Average (2-4 & 5) | | | | | | 135 | |
| 2-6 | 1500.58 | 15.96 | 1516.54 | 1.05 | 17 | 80.7 | Saturated/Coconut Oil |
| 2-7 | 1500.15 | 15.12 | 1515.27 | 1.00 | 17 | 42.3 | Saturated/Coconut Oil |
| Average (2-6 & 7) | | | | | | 61.5 | |
| 2-8 | 1500.00 | 14.97 | 1514.97 | 0.99 | 0 | 39.3 | Unsaturated/Oleic Acid |
| 2-9 | 1502.00 | 15.01 | 1517.01 | 0.99 | 0 | 32.1 | Unsaturated/Oleic Acid |
| Average (2-8 & 9) | | | | | | 36 | |
| 2-10 | 1498.00 | 15.02 | 1513.02 | 0.99 | 17 | 30.9 | Unsaturated/Oleic Acid |
| 2-11 | 1496.00 | 14.98 | 1510.98 | 0.99 | 17 | 19.3 | Unsaturated/Oleic Acid |
| Average (2-10 & 11) | | | | | | 25 | |
| 2-2 | 1500.18 | 15.40 | 1515.58 | 1.02 | Prepared | 77.0 | Unsaturated/Oleic Acid |
| | | | | | in DI | | |
| | | | | | H2O | | |
| 2-3 | 1500.42 | 15.29 | 1515.71 | 1.01 | Prepared | 65.6 | Unsaturated/Oleic Acid |
| | | | | | in DI | | |
| | | | | | H2O | | |

As shown in Table 9, samples 2-1 through 2-3, which were evaluated against results of samples 2-4 through 2-11 that comprised various grain water (0 and 17 gpg), saturated coconut oil or unsaturated oleic acid, were evaluated using a mechanical shaker. All samples showed lower FOG discharges than 0 gpg, 17 gpg, and DI water, of FIG. 2, alone. Table 10 shows an exemplary composition according to the invention containing the various demulsifiers as additives, with the removal of these demulsifiers representing the control formulation for these experiments. Formulations 2-1 through 2-3 out-performed the oil/water samples in Table 4 as demonstrated by the lower the concentration, the better FOG control provided.

TABLE 10
Exemplary composition

| Description | Wt., % |
|---|---|
| Water Deionized TNK | 17.20 |
| Sodium Alkyl Sulfosuccinate 35% (Aerosol 22; Cytec) | 0.91 |
| POTASSIUM HYDROXIDE, 45% LIQUID TNK | 64.16 |
| Water Deionized TNK | 17.73 |
| Totals | 100.00 |

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A method of reducing fat, oil, and grease discharge comprising:
adding a demulsifier to a cleaning composition to form a use solution to contact the demulsifier with a source of fat, oil and grease;
contacting the use solution with the demulsifier and cleaning composition with the source of fat, oil and grease for a sufficient amount of time to destabilize the fat, oil and grease in a waste water source, wherein the sufficient amount of time is at least about 10 minutes; and
decreasing the fat, oil and grease discharge from the waste water source to less than or equal to about 250 ppm (mg/L);
wherein the demulsifier comprises a capped block copolymer, a reverse EO/PO block copolymer, an alkyl capped alcohol ethoxylate, an alkyl pyrrolidone, a silicone polyol and/or silicone polyether; and
wherein the cleaning composition comprises an emulsifying surfactant; and
wherein the use solution comprises from about 10 ppm (mg/L) to about 100,000 ppm (mg/L) of the demulsifier.

2. The method of claim 1, wherein the waste water source is housed or passes through a discharge, drain, grease trap or grease interceptor, and wherein the demulsifier is added before the fat, oil and grease discharges from a facility with the discharge, drain, grease trap or grease interceptor.

3. The method of claim 1, wherein the method decreases the fat, oil and grease discharges in the waste water source without the additional use of a drain cleaner.

4. The method of claim 1, wherein the demulsifier is combined with an alkalinity source comprising an alkali metal hydroxide.

5. The method of claim 1, wherein the demulsifier comprises a reverse EO/PO block copolymer with about 40-50% EO.

6. The method of claim 1, wherein the demulsifier comprises the alkyl capped alcohol ethoxylate and has the structure: R₁—O—(CH₂CH₂O)ₙ—R₂ where R₂ is a linear or branched (C₁₀-C₁₈)alkyl group, R₂ is C₁-C₄, and n is an integer in the range of 1 to 100.

7. The method of claim 1, wherein the demulsifier comprises a C₈ or C₁₀ alkyl pyrrolidone.

8. The method of claim 1, wherein the demulsifier is further combined with at least one additional functional ingredient comprising an amphoteric surfactant, anionic surfactant or combination thereof.

9. The method of claim 1, wherein the use solution of the demulsifier and the cleaning composition comprises from about 20 ppm (mg/L) to about 20,000 ppm (mg/L) of the demulsifier.

10. The method of claim 1, wherein the sufficient amount of time is at least about 20 minutes, and wherein the temperature of the waste water source is between about 10° C. and about 140° C.

11. A method of using a demulsifier to destabilize fat, oil and grease in a water source comprising:
contacting a water source with fat, oil, and grease with between about 10 ppm (mg/L) to about 100,000 ppm (mg/L) of a demulsifier to form a treated water source;
wherein the contacting provides a dwell time of at least about 10 minutes that is a sufficient amount of time to destabilize the fat, oil, and grease; and
reducing the fat, oil, and grease discharged with the treated water source to less than or equal to about 250 ppm (mg/L);
wherein the demulsifier comprises a capped block copolymer, a reverse EO/PO block copolymer, an alkyl capped alcohol ethoxylate, an alkyl pyrrolidone, a silicone polyol and/or silicone polyether.

12. The method of claim 11, wherein the water source is an effluent from a facility and/or is housed in a discharge, drain, drain trap or grease interceptor.

13. The method of claim 11, wherein the demulsifier is added to the water source before the treated water is discharged.

14. The method of claim 11, wherein the demulsifier is combined with an alkalinity source comprising an alkali metal hydroxide.

15. The method of claim 11, wherein the demulsifier further comprises at least one additional functional ingredient comprising an amphoteric surfactant, anionic surfactant or combination thereof.

16. The method of claim 15, wherein the reverse EO/PO block copolymer has about 40-50% EO, wherein the alkyl capped alcohol ethoxylate having the structure: R₁—O—(CH₂CH₂O)ₙ—R₂ where R₂ is a linear or branched (C₁₀-C₁₈)alkyl group, R₂ is C₁-C₄, and n is an integer in the range of 1 to 100, or wherein the alkyl pyrrolidone is C₈ or C₁₀ alkyl pyrrolidone.

17. The method of claim 11, wherein the treated water source comprises from about 20 ppm (mg/L) to about 20,000 ppm (mg/L), or from about 30 ppm (mg/L) to about 10,000 ppm (mg/L), of the demulsifier.

18. The method of claim 11, wherein the sufficient amount of time is at least about 20 minutes, and wherein the temperature of the waste water source is between about 10° C. and about 140° C.

19. A composition for reducing fat, oil, and grease discharge comprising: a demulsifier comprising a capped block copolymer, a reverse EO/PO block copolymer, an alkyl capped alcohol ethoxylate, an alkyl pyrrolidone, a silicone polyol and/or silicone polyether;
an alkalinity source; and
at least one additional functional ingredient,
wherein the composition is a liquid or solid.

20. The composition of claim 19, wherein the composition comprises:
from about 20 to 70% of a strong alkali hydroxide, preferably 50% sodium hydroxide or 45% potassium hydroxide;
from about 0.5 to 5% of a surfactant comprising an amphoteric surfactant, anionic surfactant or combination thereof;
from about 0.5 to 5% of a defoamer comprising a capped block copolymer, a reverse EO/PO block copolymer, an alkyl capped alcohol ethoxylate, an alkyl pyrrolidone, a silicone polyol and/or silicone polyether; and
water, wherein preferably the composition is a liquid concentrate.
